(19) United States
(12) Patent Application Publication
(10) Pub. No.: US 2024/0326357 A1
(43) Pub. Date: Oct. 3, 2024

(54) STORAGE DEVICE AND METHOD FOR PRODUCING A COMPONENT FROM A DUROPLASTIC TOWPREG SEMI-FINISHED PRODUCT

(71) Applicants: AZL AACHEN GMBH, Aachen (DE); CONBILITY GMBH, Herzogenrath (DE)

(72) Inventor: Michael EMONTS, Herzogenrath (DE)

(21) Appl. No.: 18/280,386

(22) PCT Filed: Mar. 9, 2022
(86) PCT No.: PCT/DE2022/100189

§ 371 Date: Jan. 12, 2024

(30) Foreign Application Priority Data
Mar. 11, 2021 (DE) 10 2021 105 971.2

(51) Int. Cl. B29C 70/54; B29C 35/00; B29C 35/02; B29C 35/08; B29C 37/00; B29K 101/10; B29K 105/08; B29L 31/00

(52) U.S. Cl. CPC B29C 70/542; B29C 35/002; B29C 35/0288; B29C 35/08; B29C 37/001; B29C 2035/0838; B29C 2037/90; B29K 2101/10; B29K 2105/0881; B29L 2031/7156

(57) ABSTRACT

The invention relates to a placement device, a placement system, and a method of producing a component from a thermoset towpreg semi-finished product, as well as to a component. In particular the invention related to a placement device (1) for producing a component (104) from a thermoset towpreg semi-finished product (100), comprising a placement unit (2) for guiding the towpreg semi-finished product (100), a laser unit (4) for emitting a laser beam (6), and a heating section (8), wherein the laser unit (4) is arranged and configured to apply the laser beam (6) to the towpreg semi-finished product (100) in the heating area (8).

The invention relates to a placement device, a placement system, and a method of producing a component from a thermoset towpreg semi-finished product, as well as to a component.

Placement devices and methods of producing a component from thermoset towpreg semi-finished products are known in principle. Towpreg semi-finished products are unidirectional continuous fiber-reinforced thermoset pre-impregnated semi-finished products, which differ from conventional prepregs in that the matrix of towpreg semi-finished products has a dry and substantially non-tacky state at room temperature. Towpreg semi-finished products can be stored at room temperature for extended periods of time. Furthermore, towpreg semi-finished products generally do not use protective papers that separate the individual layers of conventional prepregs. Towpreg semi-finished products are also characterized by the fact that they can be heated almost as often as desired below a curative temperature, also known as the curing temperature, at which irreversible crosslinking occurs, and the matrix can thus be liquified almost as often as desired.

Towpreg semi-finished products are widely used for applications in the aerospace and automotive industries and in the manufacture of hydrogen pressure vessels made from carbon fiber reinforced plastics. An important aspect of the processing of towpreg semi-finished products is that precise process parameters are set during processing.

Towpreg semi-finished products can be processed with winding or placement units. In particular, multiple applicators with single or multiple rotary spindle systems can also be used. It is known that towpreg semi-finished products are fed to a winding unit or a deposit table at a limited feed rate, for example less than 3 m/s. This feed rate is limited, among other things, because the towpreg semi-finished products have to be warmed up to a processing temperature. This is done before winding or depositing in heating units which, for example, heat the towpreg semi-finished product by means of a heated fluid and/or infrared radiation. Such heating units are therefore essential for the production of fiber composite components, since the towpreg semi-finished product to be laid usually has to be completely heated.

For example, U.S. Pat. No. 6,451,152 B1 discloses the processing of a thermoset prepreg with a laser, whereby the wrapping area is irradiated. In addition, laser-assisted tape laying processes are known from WO 2016/078 977A1 and EP 2 895 317 B1. Here, too, low feed rates are described as essential to ensure high component qualities.

The demand for high-quality components made of fiber composites is steadily increasing. This is due to the increasing demand for components for known applications on the one hand and new areas of application, for example hydrogen tanks, on the other. However, the limited process speeds of the devices and methods of producing components from towpreg semi-finished products known in the prior art restrict the possible applications, as there is still potential for improvement in terms of manufacturing time and costs. Furthermore, the machining time for a single component increases the costs incurred in manufacturing, since the capital-intensive machines have a longer machining time per component. Existing devices and methods of producing components from thermoset towpreg semi-finished products offer various advantages, but further improvements are desirable.

It is therefore an object of the present invention to provide a placement device, a placement system and a method of producing a component from a thermoset towpreg semi-finished product, as well as a component, which reduce or eliminate one or more of said disadvantages. In particular, it is an object of the invention to provide a solution that reduces the manufacturing time for a component made of a towpreg semi-finished product and/or reduces the costs incurred in the process. It is also an object of the invention to provide a solution that improves the component quality of a component made from a towpreg semi-finished product.

This task is solved with a placement device and a method as well as a component according to the features of the independent patent claims. Further advantageous embodiments of these aspects are indicated in the respective dependent patent claims. The features listed individually in the patent claims and the description can be combined with one another in any technologically useful manner, with further embodiments of the invention being shown.

The placement device for producing the component from the thermoset towpreg semi-finished product comprises a feeder unit for guiding the towpreg semi-finished product. The placement unit preferably has one, two or more feeder elements for guiding the towpreg semi-finished product. In particular, it is preferred that the placement unit is arranged and configured to guide the towpreg semi-finished product along a guide path, the placement unit having a first guide end and a second guide end as viewed along the guide path. For example, the towpreg semi-finished product can be fed to the placement unit at the first guide end and removed from the placement unit at the second guide end. It is preferred that the guide section extends at least from a feed point to a removal point.

Furthermore, the placement device comprises a laser unit for emitting a laser beam. The laser unit is preferably a laser optics. For example, the laser optics may be couplable or coupled to a laser source using an optical fiber. The laser unit may comprise or may be a diode laser. In addition, the laser unit may be or include another laser. Further, the laser unit may be a direct emitter.

It is preferred that the laser unit has a laser power that is greater than 0.3 kilowatts, greater than 1 kilowatt, greater than 2 kilowatts, greater than 3 kilowatts, and/or greater than 4 kilowatts. It is particularly preferred that the laser power is between 1 kilowatt and 5 kilowatts, preferably between 2 kilowatts and 4 kilowatts. The wavelength range of the laser unit is preferably between 450 and 1080 nanometers. The laser unit may be a pulse laser and/or a continuous wave laser. The placement device further comprises a heating region. The heating region may also be comprised by the placement unit. The heating area is arranged in particular such that, in the intended operation of the placement device, the towpreg semi-finished product is or is guided through the heating area. The placement unit is configured in particular for guiding the towpreg semi-finished product along the guide section. The guide section preferably leads through the heating area.

The laser unit is arranged and configured to apply the laser beam to the towpreg semi-finished product in the heating area. The application of the laser beam is in particular an irradiation with the laser beam. In particular, the laser unit is arranged and configured such that the emitted laser beam impinges on the heating region. For this purpose, the laser beam can also be deflected from the laser unit towards the heating area by means of optical elements such as reflection elements.

It is preferred that the laser beam heats the towpreg semi-finished product in the heating area with a planar profile having arbitrary outer contours. For example, the laser unit may be arranged and adapted to form the laser beam such that the laser beam applies a line profile and/or a rectangular profile to the towpreg semi-finished product in the heating region. In particular, the laser unit may be arranged and adapted to apply the laser beam to the towpreg semi-finished product in the heating region by scanning the laser beam. Scanning here means that the laser unit not only images the laser beam in a stationary position, but also scans a line profile on the towpreg semi-finished product with the laser beam. Scanning is also possible with other laser beam profiles, such as the rectangular profile.

The towpreg semi-finished product is in particular a semi-finished product made of a fiber composite material comprising a plurality of unidirectionally oriented fibers, in particular carbon fibers, and a thermoset matrix, the thermoset matrix having a processing temperature, for example between 80 and 100 degrees Celsius, and a curative temperature, for example of 120 degrees Celsius.

The invention is based on the realization that existing methods for processing towpregs can be further improved. In addition, the invention is based on the realization that a further increase in component qualities is desirable in order to reduce safety factors and/or the amount of material per component, so that costs can be reduced.

The placement device enables higher process speeds by laser irradiation of the towpreg semi-finished product. Laser units have not typically been used to process towpregs because their use has not been necessary due to the process speeds previously used. The ability to use a laser unit to achieve predefined liquification of a towpreg semi-finished product surface layer increases the processing quality of the towpreg. As a result, higher quality components can be produced at lower cost.

Furthermore, the high energy input of the laser unit enables targeted tempering and thus targeted liquification of the towpreg semi-finished product, for example so that only an edge layer is liquified and not a center layer of the towpreg semi-finished product. In addition, the placement device makes it possible to set a targeted viscosity curve in a thickness direction of the towpreg semi-finished product by enabling targeted and rapid controllability of the laser-induced heat input into the towpreg semi-finished product during processing. The possibility of heating only a marginal layer of the towpreg semi-finished product allows the longitudinal tension provided in the towpreg semi-finished product to be increased during deposition, since the entire towpreg thickness is not liquified and the fibers remain correspondingly fixed in the rigid area, even at higher longitudinal tensions, so that improved processability and better component quality can also be realized here. Furthermore, heating of the towpreg semi-finished product above a curative temperature can alternatively be achieved by means of the laser beam, so that the subsequent time in the oven is reduced, since the crosslinking has already been initiated during shaping. Further, due to the much higher intensity of the laser radiation compared to the prior art, the towpreg semi-finished product can be heated faster and the towpreg semi-finished product can be heated to the desired temperature over a shorter guide distance, which significantly shortens the preheating distance and leads to significantly higher process speeds.

Furthermore, it is preferred that the placement unit has a feed unit that moves the towpreg semi-finished product in a feed direction, in particular with a feed motion. Furthermore, the placement unit may comprise a force measuring unit arranged and configured to determine a longitudinal tension of the towpreg semi-finished product. Furthermore, it is preferred that the placement unit comprises a guide roller at the second guide end, which is arranged and configured such as to allow the towpreg semi-finished product to escape with a predetermined angle.

A preferred embodiment of the placement device is characterized in that the laser unit is arranged and configured to apply the laser beam to at least a first outer surface of the towpreg semi-finished product within the heating area. The first outer surface is in particular an underside of the towpreg semi-finished product. In the processing of towpreg semi-finished products, an underside is always the side of the towpreg semi-finished product that comes into contact with a substrate, for example a winding body, a component, or a deposit table, at the time of winding. The targeted heating of the first outer surface, in particular the underside, creates a predefined processability of the towpreg semi-finished product so that improved depositing or improved winding is possible. In the case of complete heating of the towpreg semi-finished product according to the prior art and the resulting liquefaction of the complete towpreg thickness, displacements of the fibers relative to each other in cross-section can occur after winding of the towpreg semi-finished product due to the process-related towpreg stresses, which has a negative effect on the resulting component qualities. By heating the underside of the towpreg semi-finished product by laser radiation in a targeted and comparatively fast and controllable manner, it is possible to reduce or even avoid such displacements. Consequently, improved component quality is achieved.

It is furthermore preferred that the laser unit is arranged in such a way that the towpreg semi-finished product can be heated by the laser beam at a distance from a wrapping area. In particular, this means that the heating area is provided spaced from the wrapping area. As a result, heating of the towpreg semi-finished product is simplified and possible in a more targeted manner. In addition, only the underside of the towpreg is applied with laser radiation and not the wrapping area, so that the component/the already deposited towpregs are not irradiated by the laser radiation and influenced thereby. In particular, the wrapping area is the area where the towpreg semi-finished product meets a wrapping body, for example a rotationally symmetrical component. In particular, it is preferred that the heating area is located along the guide section and is spaced from the wrapping area.

A further preferred embodiment of the placement device is characterized in that the placement unit comprises a process housing through which the towpreg semi-finished product can be guided, the heating region being located inside the process housing. The guide section preferably passes through the process housing. The process housing preferably has a housing interior, wherein the heating region is located within the housing interior. The process housing preferably has a semi-finished product inlet and a semi-finished product outlet, which are arranged such that the towpreg semi-finished product enters the process housing through the semi-finished product inlet and exits the process housing through the semi-finished product outlet. In particular, the semi-finished product inlet, the semi-finished product outlet as well as a semi-finished product section connecting these two are part of the guide section. The housing interior is preferably arranged between the semi-finished product inlet and the semi-finished product outlet, and further preferably the semi-finished product inlet and the semi-finished product outlet are configured as openings of the process housing. In particular, the laser unit is arranged and configured to apply the laser beam to the towpreg semi-finished product between the semi-finished product inlet and the semi-finished product outlet.

Preferably, the process housing has radiation shielding walls that substantially shield the environment of the process housing from laser beams. Further, because the process housing already provides local laser protection, a laser protection enclosure and/or further laser protection for tolerated escaping residual scatter radiation can be dispensed with, or implemented with significantly less effort, resulting in significantly simpler and less expensive devices.

In addition, it is preferred that the process enclosure include a laser beam protection unit. The laser beam protection unit can, for example, be configured as a laser beam protection labyrinth. Preferably, the laser beam protection unit is adjacent to the semi-finished product inlet and/or the semi-finished product outlet.

Another preferred embodiment of the placement device is characterized by the laser unit being coupled to the process housing. For example, the laser unit may be disposed on the process housing or may be disposed within the process housing. The laser unit may be arranged outside the process housing, wherein the laser beam emitted by the laser unit may be guided to the heating region inside the process housing by means of optical elements and/or optically conductive elements. In particular, it is preferred that the laser unit is arranged and configured such that the laser beam emitted by the laser unit enters the process housing and is guided to the heating region. For this purpose, the laser unit can be arranged partially or completely inside the process housing. Furthermore, the laser unit can be coupled to the process housing such that the emitted laser beam is guided from the laser unit to the heating area by means of a reflection element, for example a beam splitter mirror.

A further preferred embodiment of the placement device is characterized in that the laser unit and/or the placement unit is/are arranged and configured such that the laser beam impinges substantially orthogonally on the towpreg semi-finished product. Such an arrangement of the laser unit and/or the placement unit enables particularly advantageous absorption of the laser radiation and thus efficient heating. In addition, this results in a reduction of scattered radiation entering or leaving the semi-finished product.

It is furthermore preferred that a beam splitter mirror is arranged in a beam path of the laser beam between the laser unit and the heating area, which deflects the laser beam. It is preferred that the beam splitter mirror is arranged and configured such that the laser beam is deflected by less than or equal to 90 degrees of arc and/or greater than or equal to 90 degrees of arc. In particular, it is preferred that the beam splitter mirror is set up to deflect the laser beam by 90 degrees of arc. By means of the beam splitter mirror, the arrangement of the laser unit is made more flexible. For example, the laser unit can be arranged such that the emitted laser beam is initially aligned essentially parallel to the direction of movement of the towpreg semi-finished product. By means of the beam splitter mirror, the laser beam can then be deflected such that it strikes the towpreg semi-finished product perpendicularly, for example. It is further preferred that the beam splitter mirror transmits thermal radiation generated by the towpreg semi-finished product in the heating region.

It is further preferred that the placement device comprises a first temperature measuring unit arranged and configured to determine a first temperature of the towpreg semi-finished product in the heating region. The first temperature measuring unit may be, for example, a pyrometer or a thermal camera. In particular, it is preferred that the first temperature measuring unit is arranged and configured to determine a first temperature of the first outer surface of the towpreg semi-finished product.

It is further preferred that the first temperature measuring unit is arranged and configured to detect thermal radiation transmitted through the beam splitter mirror and to determine the first temperature of the towpreg semi-finished product, in particular the first outer surface of the towpreg, in the heating region based on the detected thermal radiation.

In particular, it is preferred that the first temperature measuring unit is set up to generate and evaluate a first temperature signal characterizing the detected thermal radiation and to determine the first temperature based thereon. Furthermore, it may be preferred that the first temperature measuring unit is signal-coupled to the control device described in more detail below, and wherein the control device is set up to determine the first temperature on the basis of the first temperature signal.

Further, the placement device may comprise at least one further measuring unit arranged and adapted to detect one or more of the following quality criteria of the towpreg semi-finished product: a geometry of the towpreg semi-finished product, tolerances of the geometry of the towpreg semi-finished product, a roughness of a surface, preferably the first and/or second outer surface of the towpreg semi-finished product, and a fiber distribution of the towpreg semi-finished product. Preferably, the at least one further measuring unit is arranged to detect the one or more quality criteria before and/or after the heating region and/or in the heating region. Thus, it is possible to compare the quality criteria before, during and after heating.

Another preferred embodiment of the placement device comprises a second temperature measuring unit arranged and configured to detect a second temperature of a second outer surface of the towpreg semi-finished product opposite to the first outer surface. Preferably, the second temperature measuring unit is arranged to generate a temperature signal characterizing the second temperature and to determine the second temperature based on the second temperature signal. Further, the second temperature measuring unit may provide the second temperature signal to the control device discussed in more detail below, wherein the control device is arranged to determine the second temperature based on the second temperature signal. The second temperature measuring unit may be signal-coupled to the control device to provide the second temperature signal to the control device. By means of the second temperature measuring unit, it can be ensured or the laser unit can be adjusted such that the curative temperature is not reached in the region of the second outer surface and complete liquification of the towpreg semi-finished product is avoided.

In a further embodiment of the placement device, the placement device comprises a cooling device arranged and adapted to cool the laser unit. In particular, the cooling device may be arranged to cool the laser unit with cooling water. The placement device may further comprise a temperature measuring unit arranged and adapted to detect a temperature of the coolant before and after cooling the laser unit. If there are significant changes in the temperature difference of the two temperatures, errors in the heating of the towpreg semi-finished product can be inferred.

In a further preferred embodiment of the placement device, the placement device is provided to comprise one, two or more further temperature measuring units arranged to detect a temperature of the towpreg semi-finished product within the heating region, and/or along the guiding path or in a direction of movement of the towpreg semi-finished product before and/or after the heating region. The first, second and further temperature measuring units mentioned in the foregoing may be, for example, a pyrometer or a thermal camera and may be signal-coupled to the control device.

Furthermore, it is preferred that the placement device comprises a prestressing unit for generating a longitudinal stress in the towpreg semi-finished product. In particular, the prestressing unit is configured such that the longitudinal tension is between 0 N to more than 200 N. In particular, the prestressing unit is configured such that the longitudinal tension in the towpreg semi-finished product is more than 50 Newton, more than 100 Newton, more than 200 Newton, more than 300 Newton, more than 400 Newton, more than 500 Newton and/or more than 1000 Newton.

Furthermore, it is preferred that the placement device comprises a force measuring unit, in particular a load cell, arranged and configured to determine the longitudinal tension in the towpreg semi-finished product. It is particularly preferred that the prestressing unit is coupled to the force measuring unit, in particular is signal-coupled.

A further preferred embodiment of the placement device is characterized in that it comprises a preheating station which is arranged upstream of the heating region with respect to a direction of movement of the towpreg semi-finished product. The preheating station is configured in particular such that it heats the towpreg semi-finished product by means of a hot fluid, for example a heating gas, or infrared radiation.

A further preferred embodiment of the placement device comprises a control device, signal-coupled to the laser unit and/or to the placement unit, for controlling and/or loop-controlling at least one laser parameter of the laser unit, a feed rate of the towpreg semi-finished product and/or the longitudinal tension of the towpreg semi-finished product. Laser parameters may be the laser power, the duration of the application and/or the location of the application.

The control device is in particular set up to control the laser unit, in particular the laser power of the laser unit, such that the towpreg semi-finished product is at least partially, preferably completely, liquified by the laser beam. Liquifying means in particular that at least part of the towpreg semi-finished product is liquefied or softened. In other words, the towpreg semi-finished product is at least partially heated by the laser beam in such a way that a viscosity of the applied towpreg semi-finished product is achieved.

Furthermore, it is preferred that the control device is arranged to control the laser unit, in particular the laser power of the laser unit, such that an edge layer of the towpreg semi-finished product is liquified. It is further preferred that a center layer and another edge layer of the towpreg semi-finished product opposite the edge layer remain substantially unliquified. Preferably, the edge layer comprises the first outer surface. In particular, the center layer is arranged between the first outer surface and the second outer surface, in particular between the edge layer and a further edge layer which preferably comprises the second outer surface. By liquifying only the edge layer and not the center layer, the overall stiffness of the towpreg semi-finished product can be selectively adjusted. In addition, the possibility of movement of the individual fibers of the towpreg semi-finished product relative to each other is thereby limited, which has a positive effect on the resulting component qualities. The depth of the edge layer is preferably less than 20%, less than preferably 10% and/or less than 5% of the thickness of the towpreg semi-finished product.

Furthermore, it is preferred that the control device is set up to control the laser unit, in particular the laser power of the laser unit, such that a predefined viscosity of the edge layer is set. For this purpose, a corresponding laser power is set in particular on the basis of the known material parameters of the towpreg semi-finished product, so that the predefined viscosity is set. Furthermore, the control device can be set up to control the laser unit, in particular the laser power of the laser unit, such that the towpreg semi-finished product is heated to a temperature that corresponds at least to a curative temperature of the towpreg semi-finished product.

In a further preferred embodiment of the placement device, it is provided that the control device is arranged to control the laser unit, in particular the laser power of the laser unit, based on the first temperature, the second temperature and/or a further temperature measured of the towpreg semi-finished product within the heating region and/or a temperature measured of the towpreg semi-finished product before and/or after the heating region along the guiding path or in the direction of movement of the towpreg semi-finished product.

In a further preferred embodiment of the placement device, it is provided that correlations between material viscosities and temperatures are stored in a memory of the control device, and wherein the control device is arranged to control the laser unit based on a viscosity input characterizing a viscosity, wherein the viscosity is determined based on the stored correlations.

According to a further aspect, the above-mentioned problem is solved by a placement system for producing a component from a thermoset towpreg semi-finished product, comprising a placement device according to one of the embodiments mentioned in the foregoing and a handling unit coupled to the placement device, wherein the handling unit is arranged and configured to move the placement device. In particular, the handling unit is arranged and configured to move the placement device in one, two or three spatial directions and/or to rotate the placement device about one, two or three spatial directions. For example, the handling unit may be an articulated arm robot or a gantry machine. Furthermore, the handling unit may be a linear axis with a pivoting and/or rotating unit.

According to a further aspect, the aforementioned task is solved by a method of producing a component from a thermoset towpreg semi-finished product, in particular with a placement device according to one of the embodiments described in the foregoing, comprising the steps: Providing the thermoset towpreg semi-finished product, guiding the towpreg semi-finished product along a guide path to a placement area and/or a winding area, and heating the towpreg semi-finished product in a heating area with a laser beam, the heating area being upstream of the placement area and/or the winding area, as viewed along the guide path.

The placement area can, for example, be part of a component, a winding body, or a deposit table. In particular, the placement area is an area of the component, the winding body, or the deposit table where the towpreg semi-finished product is wound onto or deposited onto the component, the winding body or the deposit table. In other words, the placement area is the area where the towpreg semi-finished product comes into contact with the component, the winding body, or the deposit table. In particular, the heating area is located in a direction of movement of the towpreg semi-finished product before the placement area and/or the winding area. The heating of the towpreg semi-finished product in front of the placement area and/or the winding area can in particular take place in a shielded area, for example inside a process housing. It is particularly preferred that the towpreg semi-finished product is first heated and then deposited and/or wound.

It is further preferred that the heating of the towpreg semi-finished product takes place spaced apart from a wrapping area. It is further preferred that only a first outer surface, in particular an underside of the towpreg semi-finished product is heated, in particular applied with the laser beam, for example irradiated. The underside is in particular the side of the towpreg semi-finished product which subsequently contacts a laydown surface during laydown and/or winding.

Due to the high intensity of the laser radiation in combination with the possibility of fast and precise temperature-based laser power control using temperature sensors, the heating and the associated local liquification of the towpreg semi-finished product can be limited to a restricted thickness range. In addition, a targeted viscosity gradient can be set in the thickness direction.

It is further preferred that the towpreg semi-finished product is heated to a processing temperature, for example more than 80 degrees Celsius or more than 90 degrees Celsius, to a curative temperature, for example more than 120 degrees. It is further preferred that the towpreg semi-finished product is guided with a longitudinal tension of more than 20 Newton, more than 50 Newton, more than 100 Newton and/or more than 200 Newton. Furthermore, it is preferred that the towpreg semi-finished product is guided with a longitudinal tension of more than 200 Newton, preferably more than 300 Newton, in particular more than 500 Newton.

According to a further aspect, the task mentioned at the outset is solved by a component, in particular a pressure tank, preferably a gas pressure tank for gases, for example a hydrogen tank, produced by a method according to one of the embodiments described in the foregoing. The hydrogen tank is, for example, a hydrogen tank for mobile applications.

The method and its possible embodiments have features or method steps that make them particularly suitable to be used for a placement device and its embodiments.

For further advantages, embodiments and embodiment details of the further aspects and their possible further embodiments, reference is also made to the description previously provided regarding the corresponding features and further embodiments of the placement device.

Preferred embodiments are explained by way of example with reference to the accompanying figures. They show:

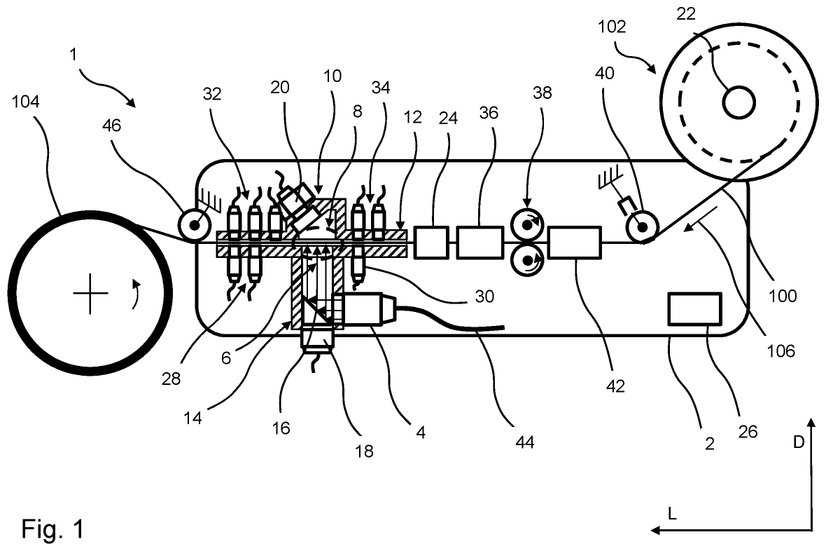

FIG. 1: a schematic, two-dimensional view of an exemplary embodiment of a placement device;

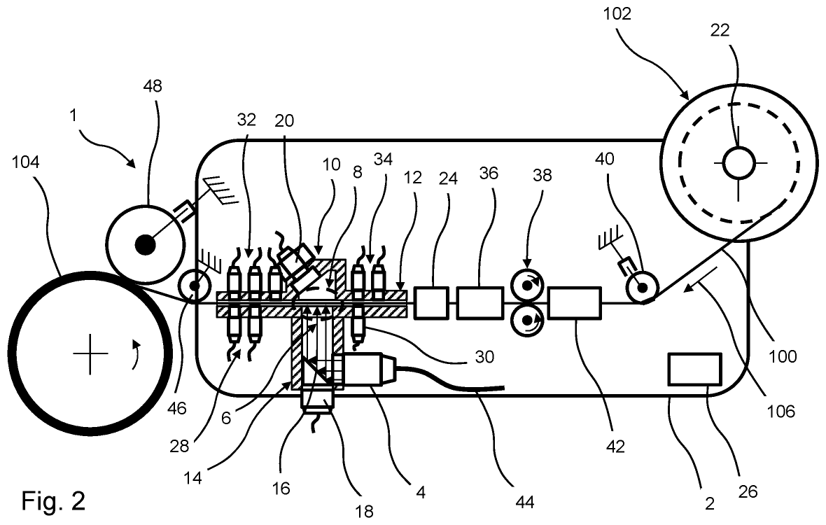

FIG. 2: a further schematic, two-dimensional view of an exemplary embodiment of a placement device;

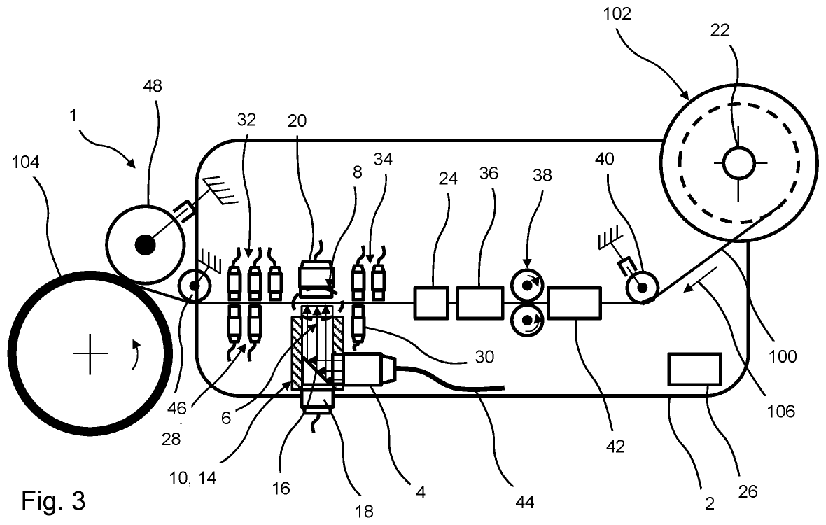

FIG. 3: a further schematic, two-dimensional view of an exemplary embodiment of a placement device;

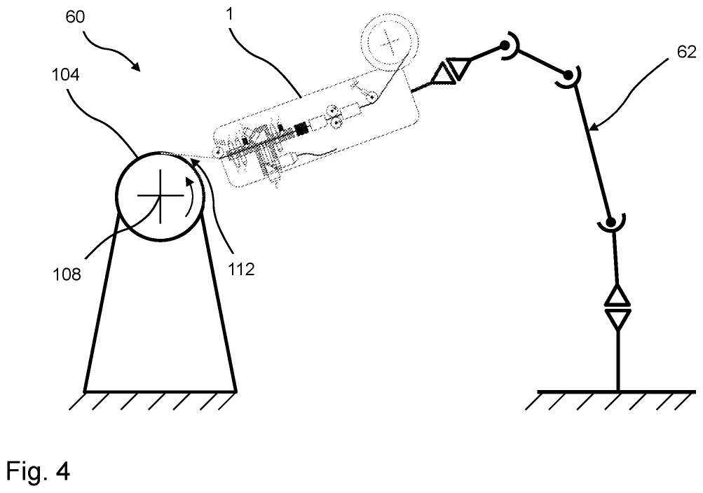

FIG. 4: a schematic, two-dimensional view of an exemplary embodiment of a storage system;

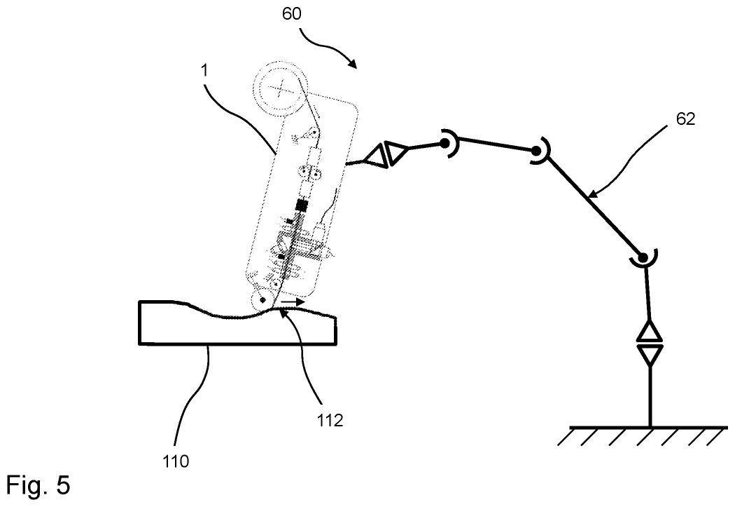

FIG. 5: a further schematic, two-dimensional view of an exemplary embodiment of a storage system; and

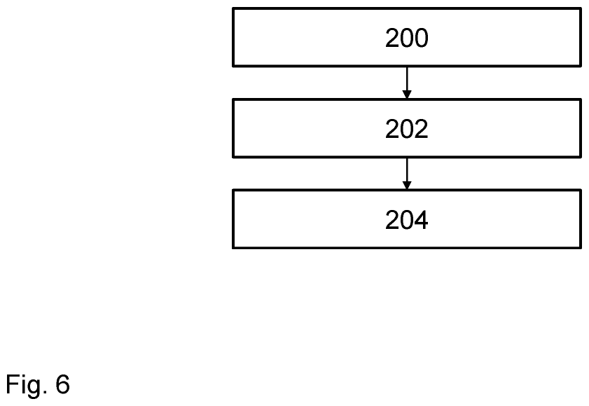

FIG. 6: a schematic method.

In the figures, identical or substantially functionally identical or similar elements are designated with the same reference signs.

FIG. 1 shows a schematic, two-dimensional view of an exemplary embodiment of a placement device 1. The placement device 1 comprises a feeder unit 2 for feeder of a towpreg semi-finished product 100. Furthermore, the placement device 1 comprises a laser unit 4 for emission of a laser beam 6. The laser unit 4 is arranged and configured such that the towpreg semi-finished product 100 can be exposed to the laser beam 6 in a heating region 8.

The placement device 1 further comprises a process housing 10. The process housing 10 has a housing inlet and a housing outlet, wherein the towpreg semi-finished product 100 is passed through the process housing 10. In particular, the towpreg semi-finished product 100 is passed through a first housing section 12 of the process housing 10, which includes the housing inlet. The process housing 10 further comprises a second housing section 14. The housing sections 12, 14 each have an interior with a passage direction. The passage direction of the first housing section 12 is substantially parallel to the movement direction 106 of the towpreg semi-finished product 100 or parallel to a guide path of the placement device 1.

The passage direction of the second housing section 14 is substantially orthogonal to the passage direction of the first housing section 12 as well as to the movement direction 106 of the towpreg semi-finished product in the area of the process housing 10.

The laser unit 4 is coupled to the process housing 10, in particular to the second housing section 14. In the second housing section 14, moreover, a beam splitter mirror 16 is arranged in the beam path of the laser beam, which deflects the laser beam 6 by 90 degrees of arc. As a result, the laser beam 6 emitted by the laser unit 4, which is initially oriented substantially parallel to the towpreg semi-finished product 100, is redirected such that the laser beam 6 impinges substantially orthogonally on the towpreg semi-finished product 100. In particular, the laser beam 6 impinges on the towpreg semi-finished product 100 within the heating area 8.

To ensure optimal processability of the towpreg semi-finished product 100, the placement device 1 comprises a first temperature measuring unit 18 and a second temperature measuring unit 20. The first temperature measuring unit 18 is arranged behind the beam splitter mirror 16, so that a thermal radiation of the heating region 8 transmitted through the beam splitter mirror 16 is detected and thus a first temperature of the towpreg semi-finished product 100 can be determined. In particular, by means of the first temperature measuring unit 18, a temperature of a first outer surface, in this case the laser-irradiated underside of the towpreg semi-finished product 100 is determined. By means of the second temperature measuring unit 20, a temperature of the second outer surface arranged opposite the lower side, in this case the upper side of the towpreg semi-finished product, is determined.

Furthermore, the placement device 1 comprises further temperature measuring units 28 to 34, by means of which the temperature, in particular a surface temperature, of the towpreg semi-finished product in the direction of movement 106 upstream of the heating region 8 and downstream of the heating region 108 is made possible.

The placement device 1 further comprises a prestressing unit 22 for generating a longitudinal tension in the towpreg semi-finished product 100, preferably the prestressing unit 22 being configured such that the longitudinal tension is loop-controlled from 0 Newton to more than 200 Newton. Furthermore, the placement device 1 comprises a preheating station 24 in which heating gas and/or infrared radiation can be used to preheat the towpreg semi-finished product 100. The guide section is to be understood as the section along which the towpreg semi-finished product 100 is guided. In FIG. 1, the guide section extends from a removal point of the prestressing unit 22, through the placement unit 2 to a wrapping/receiving/placement area of a component 104. In particular, the wrapping/receiving/placement area can be a gusset area.

The towpreg semi-finished product 100 is guided in the longitudinal direction L between the force measuring unit 40 and the guide roller 46. The longitudinal direction of the towpreg semi-finished product 100 is to be understood in particular as a main extension direction. In the direction of movement 106 in front of the force measuring unit 40, the longitudinal direction of the towpreg semi-finished product 100 is aligned in the direction of movement 106. The thickness direction of the towpreg semi-finished product 100 is oriented orthogonally to the longitudinal direction of the towpreg semi-finished product 100, in particular in the direction D. The thickness direction is the direction oriented orthogonally to a planar extent of the towpreg semi-finished product 100. In the thickness direction, the towpreg semi-finished product 100 has two edge layers between which a center layer is arranged.

In addition, the placement device 1 has a control device 26 that is signal-coupled to the laser unit 4 and the placement unit 2. The control device 26 is arranged to control and loop-control at least one laser parameter of the laser unit 4, for example a laser power, a feed rate of the towpreg semi-finished product 100 adjustable with the feed unit 38, and the longitudinal tension.

In particular, the control device 26 is arranged to control the laser unit 4 such that the towpreg semi-finished product 100 is at least partially liquified by the laser beam 6. Further, the control device 26 may be arranged to control the laser unit 4 such that a peripheral layer of the towpreg semi-finished product 100 is liquified and a central layer of the towpreg semi-finished product 100 remains substantially unliquified. In other words, a molding state of the center layer of the towpreg semi-finished product is not changed. Furthermore, the control device may be arranged such that the laser unit 4 is controlled such that a predefined viscosity of the edge layer is adjustable. Furthermore, the control device 26 may be arranged to control the laser unit 4 such that the towpreg semi-finished product 100 is heated to a temperature corresponding to at least a curative temperature of the towpreg semi-finished product 100.

In addition, the placement device 1 comprises a towpreg feeder 36, 42 arranged before and after the feed unit 38, respectively. The feed unit 38 is used to adjust a feed in the feed direction 106 of the towpreg semi-finished product 100. Furthermore, the placement device 1 comprises the prestressing unit 22. By means of the guide roller 46, the exit angle of the towpreg semi-finished product 100 from the process housing 10 is adjusted.

The placement device 1 shown in FIG. 2 has a similar structure, but here a pressure roller 48 is additionally provided, which is arranged and configured to press the towpreg semi-finished product onto the component.

FIG. 3 shows a further possible embodiment of the placement device 1. Here the process housing 10 is configured smaller and is formed in particular by the second housing section 14.

FIG. 4 shows a schematic, two-dimensional view of an exemplary embodiment of a placement system 60. The placement system 60 comprises the placement unit 1 and a handling unit 62, wherein the handling unit 62 is arranged and configured to move the placement device 1, in particular to enable a method of producing a component from a thermoset towpreg semi-finished product. The handling unit 62 is configured in the present case as an articulated arm robot. Alternatively, the handling unit 62 may also be configured as a gantry machine. The component 104 rotates about a winding axis 108, so that the component 104 winds the towpreg semi-finished product 100 substantially automatically.

In FIG. 5, the described placement system 60 is shown in connection with a depositing process. Here, the towpreg semi-finished product 100 is deposited on a placement table 100 within a placement area 112.

FIG. 6 shows a schematic method of producing a component 104 from a thermoset towpreg semi-finished product 100. In step 200, the thermoset towpreg semi-finished product 100 is provided. In step 202, the towpreg semi-finished product 100 is guided to the placement area 112. In step 204, the towpreg semi-finished product 100 is heated with a laser beam 6 before the placement area 112. The towpreg semi-finished product 100 is heated with the laser beam 6 as seen along the guiding path of the towpreg semi-finished product 100 just before the laydown or winding process.

Due to the high intensity of the laser radiation in combination with the laser power control, the heating and the associated local liquification of the towpreg semi-finished product can be limited to a restricted thickness range of the towpreg semi-finished product. Thus, a targeted viscosity gradient in the thickness direction can be set and improved processing of the towpreg semi-finished product 100 can be ensured. The heating of the towpreg semi-finished product 100 is spaced apart from a wrapping area. For example, the towpreg semi-finished product may be heated to a processing temperature, such as 80 degrees. Alternatively, the towpreg semi-finished product may be heated to a curative temperature, such as greater than 120 degrees. The inventors have found that when the towpreg semi-finished product 100 is heated to a temperature above the curative temperature, subsequent processing in the oven can be significantly reduced.

### REFERENCE SIGNS

1 placement device
2 placement unit
4 laser unit
6 laser beam
8 heating area
10 process housing
12 first housing section
14 second housing section
16 beam splitter mirror
18 first temperature measuring unit
20 second temperature measuring unit
22 prestressing unit
24 preheating station
26 control unit
28 temperature measuring units
30 temperature measuring units
32 temperature measuring units
34 temperature measuring units
36 towpreg feeder
38 feed unit
40 force measuring unit
42 towpreg feeder
44 laser optical fiber
46 guide roller
48 pressure roller
60 placement system
62 handling unit
100 towpreg semi-finished product
102 material spool
104 component
106 direction of movement
108 winding axis
110 deposit table
112 placement area

1. Placement device for producing a component from a thermoset towpreg semi-finished product, comprising
a placement unit for guiding the towpreg semi-finished product,
a laser unit for emitting a laser beam, and
a heating section,
wherein the laser unit is arranged and configured to apply the laser beam to the towpreg semi-finished product in the heating area.

2. Placement device according to claim 1, wherein the laser unit is arranged and configured to apply the laser beam to at least a first outer surface of the towpreg semi-finished product within the heating area.

3. Placement device according to claim 1, wherein the placement unit comprises a process housing through which the towpreg semi-finished product can be passed, wherein the heating area is located within the process housing.

4. Placement device according to claim 1, wherein the laser unit is coupled to the process housing, in particular is arranged on or in the process housing.

5. Placement device according to claim 1, wherein
the laser unit and/or the placement unit is/are arranged and configured such that the laser beam impinges substantially orthogonally on the towpreg semi-finished product, and/or
a beam splitter mirror is arranged in a beam path of the laser beam between the laser unit and the heating region, which mirror deflects the laser beam, by 90 degrees, and/or transmits a thermal radiation generated by the towpreg semi-finished product in the heating region.

6. Placement device according to claim 1,
comprising a first temperature measuring unit arranged and configured to determine a first temperature of the towpreg semi-finished product in the heating region, and/or
comprising the first temperature measuring unit, wherein the first temperature measuring unit is arranged and configured to detect thermal radiation transmitted through the beam splitter mirror and to determine the first temperature of the towpreg semi-finished product in the heating area based on the detected thermal radiation.

7. Placement device according to claim 1, comprising a second temperature measuring unit arranged and configured to detect a second temperature of a second outer surface of the towpreg semi-finished product opposite to a first outer surface of the towpreg semi-finished product.

8. Placement device according to claim 1, comprising a prestressing unit for generating a longitudinal tension in the towpreg semi-finished product, the prestressing unit being configured such that the longitudinal tension is between 0 N to more than 200 N.

9. Placement device according to claim 1, comprising a preheating station arranged upstream of the heating area with respect to a direction of movement of the towpreg semi-finished product.

10. Placement device according to claim 1, comprising a control device, signal-technically coupled to the laser unit and/or to the placement unit, for controlling and/or loop-controlling at least one laser parameter of the laser unit, a feed speed of the towpreg semi-finished product and/or a longitudinal tension of the towpreg semi-finished product, wherein:
the control device is set up to control the laser unit in such a way that the towpreg semi-finished product is at least partially, or completely liquified by the laser beam,
the control device is arranged to control the laser unit such that an edge layer of the towpreg semi-finished product is liquified, and/or
the control device is set up to control the laser unit such that a predefined viscosity of the edge layer is set, and/or
the control device is set up to control the laser unit such that the towpreg semi-finished product is heated to a temperature which corresponds at least to a curative temperature of the towpreg semi-finished product.

11. Placement device according to claim 1, wherein the comprising a control device is arranged to control the laser unit based on a first temperature of the towpreg semi-finished product in the heating region, a second temperature of a second outer surface of the towpreg semi-finished product and/or another temperature measured of the towpreg semi-finished product within the heating area and/or a temperature measured of the towpreg semi-finished product before and/or after the heating area in the direction of movement of the towpreg semi-finished product.

12. Placement system for producing a component from a thermoset towpreg semi-finished product, comprising
the placement device according to claim 1, and
a handling unit coupled to the placement device,
wherein the handling unit is arranged and configured to move the placement device.

13. Method of producing a component from a thermoset towpreg semi-finished product with the placement device according to claim 1, comprising the steps:
providing the thermoset towpreg semi-finished product,
guiding the towpreg semi-finished product along a guiding path to a placement area and/or a winding area, and
heating the towpreg semi-finished product in a heating area with a laser beam, wherein the heating area is along the guide path upstream of the placement area and/or the winding area.

14. Method according to claim 13, wherein the heating of the towpreg semi-finished product is spaced apart from a wrapping area.

15. Method according to claim 13, wherein the towpreg semi-finished product is heated to a processing temperature of, for more than 80° C. or more than 90° C., and/or to a curative temperature more than 120° C.

16. Method according to claim 13, wherein the towpreg semi-finished product is guided with a longitudinal tension of more than 20 N, more than 50 N, more than 100 N and/or more than 200 N.

17. A gas pressure tank for gases manufactured by the method according to claim 13.

18. The pressure tank according to claim 17, wherein the gas pressure tank comprises a hydrogen pressure tank.
